(19) United States
(12) Patent Application Publication
(10) Pub. No.: US 2015/0036187 A1
(43) Pub. Date: Feb. 5, 2015

(54) PRINTING CONTROL APPARATUS, PRINTING CONTROL METHOD AND PRINTING CONTROL PROGRAM

(71) Applicant: SEIKO EPSON CORPORATION, Tokyo (JP)

(72) Inventors: Mai KUBOTA, Shiojiri-shi (JP); Naoki SUDO, Shiojiri-shi (JP)

(21) Appl. No.: 14/447,488

(22) Filed: Jul. 30, 2014

(30) Foreign Application Priority Data
Aug. 2, 2013 (JP) 2013-161078

(51) Int. Cl. G06K 15/02

(52) U.S. Cl. CPC G06K 15/1809; G06K 15/021
USPC 358/1.15

(57) ABSTRACT

A printing control apparatus for controlling printing on a lenticular sheet includes a printing control section that generates printing data corresponding to an area included in the lenticular sheet as well as another printing data corresponding to at least one area extending outward from an edge of the lenticular sheet, and that performs printing by using the printing data and the another printing data. The printing data and the another printing data are composed of a plurality of pixels, and for the another printing data corresponding to the outer area than the edge, when a row of pixels being included in the plurality of pixels and aligning so as to correspond to a long-direction of a lenticular lens is defined as a pixel row, the printing control apparatus performs thinning-out processing by handling a predetermined number of the pixel row as unit of the thinning-out processing.

### CROSS-REFERENCE TO RELATED APPLICATIONS

This application claims priority to Japanese Patent Application No. 2013-161078 filed on Aug. 2, 2013. The entire disclosure of Japanese Patent Application No. 2013-161078 is hereby incorporated herein by reference.

### BACKGROUND

1. Technical Field

The present invention relates to a printing control apparatus, a printing control method and a printing control program.

2. Related Art

There has been known printing processing which is called “frameless (marginless) printing” or the like, and which allows recording on the whole face of a recording medium without providing no margin at a vicinity of an edge of the recording medium. In such frameless printing, in order to remove margins with certainty even when there exist a tilt of a recording medium in the state of being transported, error in the size of the recording medium, and the like, inks are ejected onto a range larger than the size of the recording medium. That is, inks are ejected onto an outer area than the edge of the recording medium. Such ejection of inks onto an outer area than the edge of the recording medium is expressed by “throwing away”. Basically, thrown-away inks land on an ink absorber provided in a printer, but part of the thrown-away inks flies inside the printer as fine ink mist, and, sometimes, brings pollution to the inside of the printer. For this reason, in frameless printing, although throwing away of inks is necessary, it has been desired to reduce an amount of thrown-away inks as much as possible.

As a related technology, there has been known an ink jet recording method which, when performing recording by ejecting inks from a recording head onto an area on a recording medium as well as an area extending outward from an edge of the recording medium, performs thinning out of recording data corresponding to the area extending outward from the edge of the recording medium, and performs recording on the basis of the thinned-out recording data (refer to JP-A-2007-152791).

Further, in a liquid ejecting apparatus which ejects liquid droplets, which have been subjected to thinning-out processing, onto a vicinity of an edge of a recording medium on the basis of a thinning-out pattern which prescribes a way of thinning out of liquid droplets to be ejected onto the recording medium, there has been known a configuration for determining the thinning-out pattern in accordance with a printing mode (refer to JP-A-2005-225194).

In frameless printing, there occurs a case where part of inks to be thrown away is not actually thrown away but lands on a recording medium due to a tilt of the recording medium in the state of being transported, error in the size of the recording medium, and the like. For this reason, there has been a problem that, when thinning-out processing is performed on data which prescribes inks to be ejected onto an outer area than an edge of a recording medium, portions each having been thinned out (i.e., portions each having been inhibited from ejecting corresponding inks in the thinning-out processing) are likely to appear on the printing medium as margins, thereby, as a result, causing an image quality as frameless printing to degrade.

Meanwhile, there has been known a technology which provides a user with a three-dimensionally viewed printing result by performing printing of an image resulting from combining a plurality of viewpoint images (hereinafter, this image being also referred to as a lenticular image) on a recording medium provided with a lenticular lens. In the case where frameless printing is performed when performing printing of such a lenticular image, there also occurs a problem of the degradation of an image quality due to thinning-out processing, such as described above. Further, there has been required a method for preventing the occurrence of a degradation of an image quality, which is particularly likely to occur under a situation where a lenticular image is frameless-printed on a recording medium provided with a lenticular lens.

### SUMMARY

An advantage of some aspects of the invention is to provide a printing control apparatus, a printing control method and a printing control program which enable reduction of an amount of ink thrown away and, simultaneously therewith, suppression of the degradation of an image quality.

According to an aspect of the invention, a printing control apparatus for controlling printing on a lenticular sheet includes a printing control section that generates, from image data for use in the printing on the lenticular sheet, printing data corresponding to an area included in the lenticular sheet as well as another printing data corresponding to at least one area extending outward from an edge of the lenticular sheet, and that performs printing by using the printing data and the another printing data. Further, the printing data and the another printing data are composed of a plurality of pixels, and for the another printing data corresponding to the outer area than the edge, when a row of pixels being included in the plurality of pixels and aligning so as to correspond to a long-direction of a lenticular lens is defined as a pixel row, the printing control apparatus performs thinning-out processing by handling a predetermined number of the pixel row as unit of the thinning-out processing.

According to this configuration, the printing control section becomes capable of reducing an amount of an ink thrown away when frameless printing is performed by thinning out the another printing data corresponding to the outer area than the edge of the lenticular sheet. Additionally, since thinning-out processing is performed by handling a predetermined number of the pixel row as unit of the thinning-out processing, even in the case where, supposedly, any thinned-out portion results in landing on the lenticular sheet, the degradation of a printing result can be suppressed as much as possible.

According to another aspect of the invention, the image data for use in the printing on the lenticular sheet may be arranged so as to cause a plurality of partial image areas to correspond to a short-direction of the lenticular lens, and the predetermined number may be a total number of a plurality of the pixel rows which is associated with a corresponding one of the partial image areas.

According to this configuration, since thinning-out processing on data is performed by handling, as unit of the thinning-out processing, the plurality of pixel rows each associated with a corresponding one of the partial image areas, even in the case where, supposedly, any thinned-out portion results in landing on the lenticular sheet, only a three-dimensional appearance at an edge of the image is slightly lost in a printing result, and the degradation of an image quality viewed by a user can be suppressed as much as possible.

According to another aspect of the invention, the printing control section may be configured to, for the another printing data corresponding to the outer area than the edge, make a thinning-out ratio higher as being further distanced from the edge.

According to this configuration, a possibility that the thinned-out portion results in landing on the lenticular sheet is significantly decreased, and as a result, the degradation of an image quality can be suppressed.

According to another aspect of the invention, the printing control section may be configured to, for the another printing data corresponding to the outer area than the edge, perform dividing into a first area near the edge and a second area distanced from the edge, and perform the thinning-out processing on only the second area.

According to this configuration, a possibility that the thinned-out portion results in landing on the lenticular sheet is significantly decreased, and as a result, the degradation of an image quality can be suppressed.

According to another aspect of the invention, the printing control section may be configured to, when a first printing mode for use in performing printing of a lenticular image by ejecting an ink onto an inner area and an outer area than an edge of the lenticular sheet is directed, perform thinning out of data on printing data corresponding to the outer area than the edge by handling the predetermined number of the pixel row as unit of the thinning out of data, and when a second printing mode, which is different from the first printing mode and which is for use in performing printing of an image by ejecting an ink onto an inner area and an outer area than the edge of a given recording medium other than the lenticular sheet, is directed, perform thinning out of pixels at regular or irregular intervals in each of two mutually orthogonal directions on printing data corresponding to the outer area than the edge.

According to this configuration, depending on whether printing is frameless printing of a lenticular image on a lenticular sheet or frameless printing other than the frameless printing of a lenticular image on a lenticular sheet, an optimum thinning-out method for each of the two kinds of frameless printing is selected, and in each of the two kinds of frameless printing, it is possible to reduce an amount of an ink thrown away and suppress the degradation of an image quality.

A technical concept associated with the invention is not only realized from the aspect of the printing control apparatus, but also may be embodied from other aspects. Further, it is possible to recognize an invention of a method (a printing control method) including processes corresponding to the features of the aforementioned printing control apparatus according to any of the above aspects; an invention of a printing control program which causes given hardware (a computer) to execute the above method; and an invention of a recording medium recording the above program therein and being readable from a computer. Further, the printing control apparatus may be realized by a single apparatus, or may be realized by a combination of a plurality of apparatuses.

### BRIEF DESCRIPTION OF THE DRAWINGS

The invention will be described with reference to the accompanying drawings, wherein like numbers reference like elements.

FIG. 1 is a diagram schematically illustrating a hardware configuration and a software configuration according to an embodiment of the invention.

FIG. 2 is a diagram for briefly describing printing of a lenticular image according to an embodiment of the invention.

FIG. 3 is a flowchart illustrating printing control processing according to an embodiment of the invention.

FIG. 4 is a diagram illustrating a comparison between the size of image data for frameless printing and the size of a lenticular sheet according to an embodiment of the invention.

FIGS. 5A and 5B are diagrams for describing an area within printing data which is targeted for thinning-out processing according to an embodiment of the invention.

FIG. 6 is a diagram for describing an example of thinning-out processing according to an embodiment of the invention.

FIG. 7 is a diagram for describing an example of thinning-out processing as a comparison example, according to an embodiment of the invention.

### DESCRIPTION OF EXEMPLARY EMBODIMENTS

Hereinafter, embodiments according to the invention will be described with reference to the drawings.

### 1. Outline of Apparatus

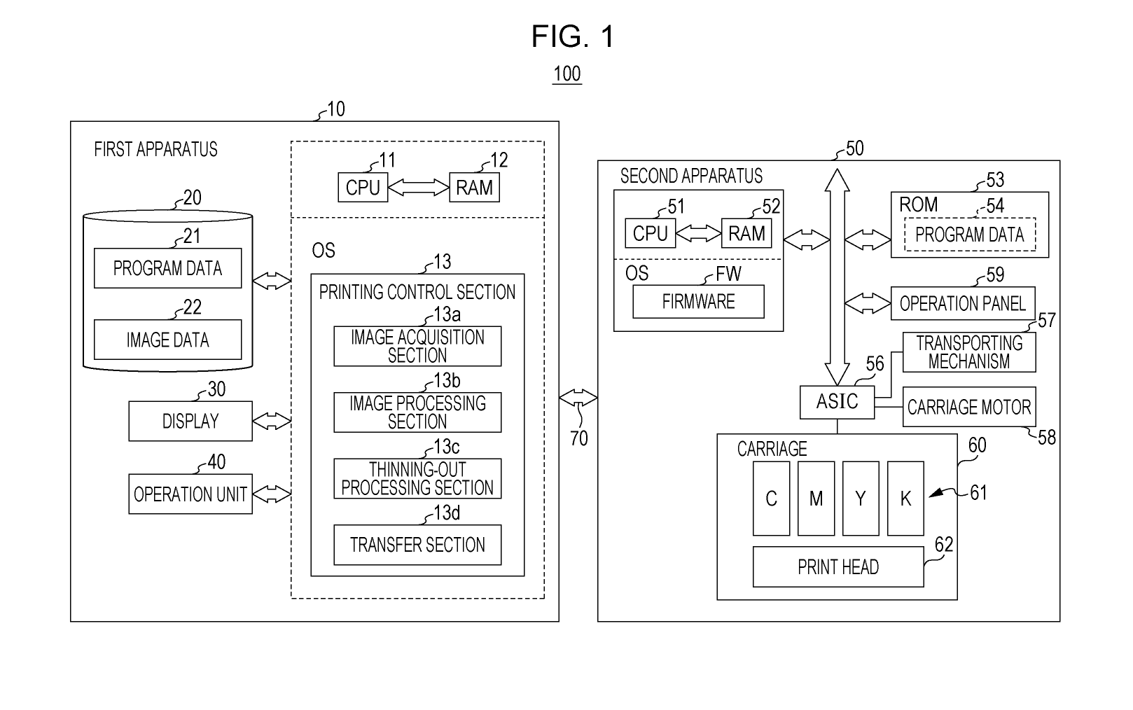

FIG. 1 schematically illustrates a hardware configuration and a software configuration according to this embodiment. FIG. 1 illustrates a first apparatus 10 and a second apparatus 50. The first apparatus 10 performs control of the second apparatus 50 so as to cause the second apparatus 50 to carry out printing, and corresponds to, for example, a personal computer (PC), a server, a mobile terminal apparatus or the like. The second apparatus 50 is a printer. A printer is an output apparatus that generates a hard copy record of data by handling, as a main form, a string of discrete graphic characters belonging to a single predetermined character set or a plurality of predetermined character sets (JIS X 0012-1990). The second apparatus 50 may be any apparatus capable of functioning as a printer, and may be a so-called multi-function device which functions as a scanner or a copy machine.

The first apparatus 10 corresponds to an example of a printing control apparatus. Alternatively, a system 100 including the first apparatus 10 and the second apparatus 50 may be regarded as a printing control apparatus, or only the second apparatus 50 can be regarded as a printing control apparatus. Further, the first apparatus 10 and the second apparatus 50 are not based on only the assumption that these are mutually different apparatuses. The first apparatus 10 and the second apparatus 50 may correspond to their respective associated portions inside an integrally formed single product (a printer), and a configuration in which a portion of the relevant product functions as the first apparatus 10 and the other portion thereof functions as the second apparatus 50 is also included in this embodiment.

In the first apparatus 10, a printing control section 13 (a printing control program, such as a printer driver) for controlling the second apparatus 50 is executed by causing a CPU 11 to write program data 21 stored in a hard disc drive (HDD) 20 or the like into a RAM 12 and perform an arithmetic operation in accordance with the program data 21 under an OS. The printing control section 13 causes a CPU 11 to execute individual functions of an image acquisition section 13a, an image processing section 13b, a thinning-out processing section 13c, a transferring section 13d and the like. These individual functions will be described below. In the case where the apparatus 10 and the second apparatus 50 are integrally formed as a printer, the printing control section 13 may be configured as firmware FW, and the HDD 20 may be configured as a memory, such as a ROM 53.

A display 30 functioning as a display unit is connected to the first apparatus 10, and user interface (UI) screens necessary for individual processes are displayed on the display 30. Further, the first apparatus 10 is provided with an operation unit 40, which may be realized by any one or more of components, such as a keyboard, a mouse device, various buttons, a touch pad and a touch panel, in a sensible way, and directions necessary for individual processes are inputted by a user via this operation unit 40. In addition, the display 30 and the operation unit 40 may be incorporated in the first apparatus, or may be externally connected thereto. The first apparatus 10 is connected to the second apparatus 50 via a transfer path 70 so as to be communicable therewith. The transfer path 70 is a collective term of a wired communication path and a wireless communication path. As described above, in the case where the first apparatus 10 and the second apparatus 50 are included in an integrally formed product, the transfer 70 is a communication path inside the relevant product.

In the second apparatus 50, firmware for controlling the second apparatus 50 itself is executed by causing a CPU 51 to write program data 54 stored in a ROM 53 or the like into a RAM 52 and perform an arithmetic operation in accordance with the program data 54 under an OS. The firmware FW is capable of causing an ASIC 56 to perform printing based on printing data having been transmitted from the first apparatus 10.

The ASIC 56 acquires the printing data, and generates driving signals for driving a transporting mechanism 57, a carriage motor 58 and a print head 62. The second apparatus 50 is provided with, for example, a carriage 60, and this carriage 60 includes ink cartridges 61 each associated with a corresponding one of a plurality of kinds of inks. In an example shown in FIG. 1, there are mounted the ink cartridges 61 each associated with a corresponding one of inks, that is, a cyan (C) ink, a magenta (M) ink, a yellow (Y) ink and a black (K) ink. In this regard, however, specific kinds and a total number of inks for use in the second apparatus 50 are not limited to those described above, and various inks whose colors are, for example, light cyan, light magenta, orange, green, gray, light gray, white, metallic and the like can be used. Further, the cartridges 61 may not be mounted in the carriage 60 but may be provided in a given position inside the second apparatus 50, and further, each of the cartridges 61 may be provided in the form of an ink tank, an ink package or the like.

The carriage 60 includes a print head 62 for ejecting inks, each supplied from a corresponding one of the cartridges 61, through a large number of ink ejecting holes (hereinafter, referred to as nozzles). The print head 62 is provided, for each of the nozzles, with a piezoelectric element for ejecting ink droplets (dots) through the nozzle. Upon supply of the driving signal, the piezoelectric element is deformed, thereby causing a dot to be ejected through a corresponding one of the nozzles. The transporting mechanism 57, which includes a paper feeding motor and a paper feeding roller (which are not illustrated), transports a recording medium along a predetermined transportation direction by being drive-controlled by the ASIC 56. This recording medium is a material for retaining printed images thereon.

The carriage motor 58 is drive-controlled by the ASIC 56, so that the carriage 60 (including the print head 62) moves along a direction intersecting with the transportation direction (hereinafter, this direction being referred to as a main-scanning direction), and the ASIC 56 causes the print head 62 to eject inks through the nozzles in conjunction with the movement of the carriage 60. Through this operation, dots are adhered onto the recording medium and images based on printing data are reproduced on the recording medium. In addition, the expression “intersecting with” means an expression “orthogonal to”. In this regard, however, the expression “orthogonal to” does not mean a rigorous orthogonal state (i.e., 90 degrees), but means an orthogonal state including a degree of angular error, which is allowable from a viewpoint of a product quality.

The second apparatus 50 further includes an operation panel 59. This operation panel 59, which includes a display unit (for example, a liquid crystal panel), a touch panel formed inside this display unit, and various buttons and keys, receives inputs from a user, and displays necessary UI screens on the display unit.

The second apparatus 50 is not limited to a so-called serial printer in which the print head 62 moves along the main-scanning direction as described above. For example, the second apparatus 50 may be a so-called line printer including a line-printer head provided with a plurality of nozzle rows, each of which includes nozzles aligning along a main-scanning direction and is associated with a corresponding one of ink kinds, and which are arranged in parallel with each other in the transportation direction. Further, a means for ejecting dots through a nozzle is not limited to the aforementioned piezoelectric element, and a means for causing a heat generation element to heat an ink and eject a dot thereof through a nozzle may be employed. Moreover, a printing method employed in a printer is not necessarily limited to such an ink jet method as described below, but may be a laser method or a thermal method.

### 2. Brief Description of Printing of Lenticular Image

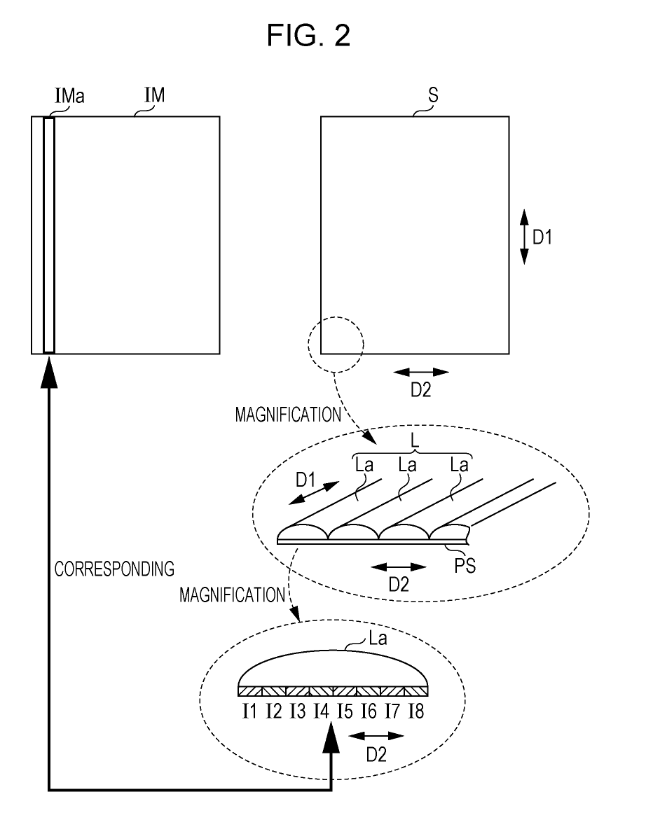

Next, printing of a lenticular image performed in this embodiment will be briefly described on the basis of FIG. 2. FIG. 2 illustrates a lenticular image IM at an upper-left side and a lenticular sheet S at an upper-left side. This lenticular image IM is an image resulting from combining a plurality of viewpoint images, and it is supposed, here, that it is in a bit-map data state. For example, the lenticular image IM is obtained such that a plurality of images (viewpoint images) obtained by taking a picture of a certain subject from a plurality of different viewpoints are each carved up into fine strip-shaped images; a plurality of these carved-up strip-shaped images are collected up into bundles of strip-shaped images; and these bundles of strip-shaped images are compressed into an image of a single sheet size. The number of the viewpoint images which are bases of the generation of the lenticular image IM is not particularly limited, and in description of FIG. 2, the number of the viewpoint images is made eight as an example.

The lenticular sheet S is a kind of a recording medium, and is provided with a lenticular lens L on one of faces thereof. The lenticular lens L includes a plurality of lenses (unit lenses La) each having a long shape and a hemispherical-shaped cross section. In a middle portion of FIG. 2, a perspective view resulting from magnifying part of the lenticular sheet S is exemplified. The plurality of unit lenses La constituting the lenticular lens L are arranged in a direction parallel with their respective short-direction sides, so as to cause their respective long-direction sides to be parallel with one another. Here, with respect to the lenticular sheet S, a direction parallel with the long-direction sides of the unit lenses La (i.e., the long-direction side of the lenticular lens L) is denoted by a direction D1, and a direction parallel with the short-direction sides of the unit lenses La (i.e., the short-direction side of the lenticular lens L) is denoted by a direction D2. Further, a face reverse to the face on which the lenticular lens L of the lenticular sheet S is arranged is called a recording face PS. The lenticular image IM is printed on the recording face PS. A user can three-dimensionally view a subject represented by the lenticular image IM by seeing such a printing result from the face on which the lenticular lens L is arranged.

The lenticular image IM includes long-shaped image areas IMa each having a total number equivalent to that of the unit lens La, and having a size substantially the same as that of the unit lens. A single image area IMa is an image resulting from collecting up the aforementioned strip-shaped images. That is, as described above, when the number of the viewpoint images is eight, a single image area IMa is composed of a bundle of eight kinds of strip-shaped images resulting from carving up their respective corresponding eight viewpoint images. In a lower portion of FIG. 2, a state where a plurality of images constituting a single image area IMa (i.e., eight kinds of strip-shaped images I1, I2, I3, I4, I5, I6, I7 and I8 each resulting from carving up a corresponding one of eight viewpoint images) are printed so as to be arranged in the direction D2 is exemplified by using a magnified diagram. Each of the images I1, I2, I3, I4, I5, I6, I7 and I8 corresponds to the “partial image area” in the appended claims. Further, the number of the images I1, I2, I3, I4, I5, I6, I7 and I8 corresponds to the number of viewpoints contained in a single unit lens La, and thus, each of these images is also called just a “viewpoint”.

### 3. Printing Control Processing

Based on the configuration described above, printing control processing performed in this embodiment will be described.

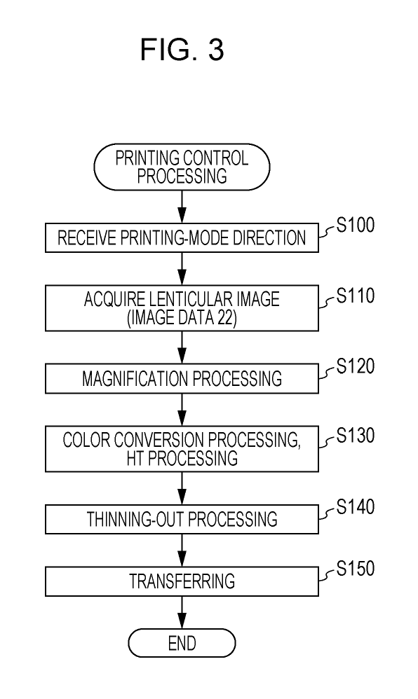

FIG. 3 illustrates printing control processing by using a flowchart. Here, description will be made on an assumption that, in the apparatus 10, the CPU 11 executes the relevant flowchart to realize the function of the printing control section 13.

In step S100, the printing control section 13 receives a user's various settings on printing via UI screens the user has displayed on the display 30 by operating the operation unit 40. Particularly, the printing control section 13 receives a direction of a printing mode. There is a plurality of printing modes which can be directed by a user, and it is supposed, here, that a first printing mode has been directed. The first printing mode is a printing mode for allowing the lenticular image IM to be frameless-printed on the lenticular sheet S.

In step S110, the image acquisition section 13a acquires image data 22 (bit-map data) a user has selected as an image to be printed on a recording medium. This image data 22, which represents the lenticular image IM, is generated in advance by, for example, given application software, and is stored in the HDD 20 or the like. That is, the image data 22 is a kind of image data for use in performing printing on a lenticular sheet. Alternatively, the image acquisition section 13a may be configured so as to acquire (download) the image data 22 representing the lenticular image IM, which is already generated by a different person, from an external server or the like connected to a network (which are not illustrated).

In step S120, the image processing section 13b magnifies the image data 22. A currently directed printing mode is the first printing mode and this mode is a mode which allows frameless printing, and thus, in order to realize the frameless printing, the image processing section 13b converts the number of pixels so as to make the size of the image data 22 larger than that of the lenticular sheet S.

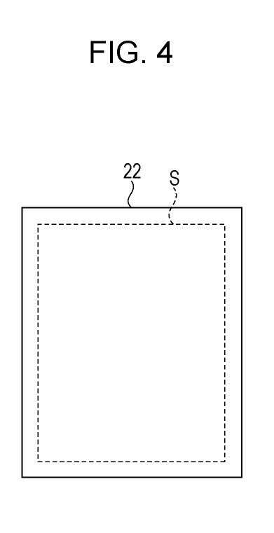

FIG. 4 is a diagram illustrating a comparison between the size of the image data 22 having been subjected to the processing in step S120 and the size of the lenticular sheet S. In FIG. 4, the size of the image data 22 is denoted by a full line, and the size of the lenticular sheet S is denoted by a chain line. According to FIG. 4, the number of pixels included in the image data 22 is adjusted so as to cause the size of the image data 22 to extend outward from the size of the lenticular sheet S in each of two mutually orthogonal axis directions (a vertical direction and a horizontal direction of the image). In addition, it is supposed that, in the frameless printing, it is predetermined to what degree of a ratio of the size of the image data relative to the size of the recording medium the image data is to be magnified.

In step S130, the image processing section 13b performs various necessary image processes on the image data 22 having been subjected to the processing in step S120. Specifically, the image processing section 13b performs color conversion processing for converting a color display system of the image data 22 into a color display system employed in a printer (the second apparatus 50). For example, in the case where the image data 22 is RGB data which includes, for each pixel, gray-scale values each associated with a corresponding one of red (R), green (G) and blue (B), the image processing section 13b converts the RGB values per pixel for the image data 22 into CMYK values corresponding to a combination of ink amounts each associated with a corresponding one of C, M, Y and K (each of the ink amounts corresponding to, for example, one of 256 gray-scale levels from “0” to “255”). This color conversion processing can be performed by referring to a lookup table predetermining a correspondence relation between the RGB and the CMYK. Further, the image processing section 13b performs halftone (HT) processing on the image data 22 having been subjected to the color conversion processing. Through this halftone processing, the image data 22 is converted into printing data 22′ (halftone data) which prescribes, for each pixel, the ejection (dot-on) or non-ejection (dot-off) of each of CMYK dots. This halftone processing can be realized by means of a dither method, an error dispersion method or the like.

In step S140, the thinning-out processing section 13c performs processing for thinning out data with respect to the printing data 22′ having been obtained through the processing in step S130. The printing data 22′ represents the lenticular image IM, and further corresponds to an example of printing data corresponding to an inner area than each of edges of the lenticular sheet S (i.e., an area included in the lenticular sheet S), and another printing data corresponding to an outer area than each of the edges of the lenticular sheet S (i.e., an area extending outward from each of the edges of the lenticular sheet S).

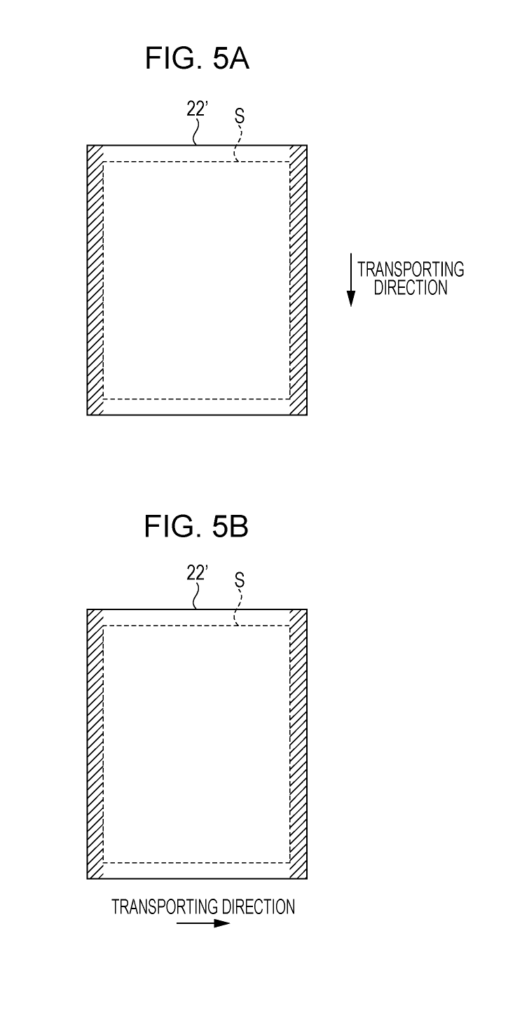

FIGS. 5A and 5B are diagrams each for describing an area within the printing data 22′, which is targeted for thinning-out processing performed in step S140. FIG. 5A illustrates a case where, in the second apparatus 50, the transportation direction of the lenticular sheet S is parallel with the long-direction side of the lenticular lens L (refer to FIG. 2), and FIG. 5B illustrates a case where, in the second apparatus 50, the transportation direction of the lenticular sheet S is orthogonal to the long-direction side of the lenticular lens L (refer to FIG. 2). In this case, similarly, the expression “parallel with” and the expression “orthogonal to” do not mean a rigorous parallel state and a rigorous orthogonal state, respectively, but they each mean a state including a degree of error (tilt), which is likely to occur in actual products.

In step S140, among the pieces of printing data 22′, pieces of data, which correspond to an outer area than each of the edges of the lenticular sheet S, and further, do not include pieces of data located on extended lines of the long-shaped unit lenses La, are made pieces of data targeted for thinning-out processing. Here, the expression “pieces of data which correspond to an outer area than each of the edges of the lenticular sheet S” means pieces of data which prescribe inks to be ejected (thrown away) to the outside of each of the edges of the lenticular sheet S. In the above description, a reason why the expression “to be ejected” is used is that, in an actual situation, there is a case where part of inks to be thrown away lands on the lenticular sheet S due to a tilt of the lenticular sheet S in the state of being transported, error in the size the lenticular sheet S, and the like. Further, the expression “pieces of data located on extended lines of the long-shaped unit lenses La” means pieces of data corresponding to an outer area than each of the edges of the lenticular sheet S in a direction corresponding to the long-direction side of the lenticular lens L.

In FIGS. 5A and 5B, data targeted for such thinning-out processing is clearly illustrated by means of hutching. That is, in the case where the second apparatus 50 transports the lenticular sheet S in a direction parallel with the long-direction side of the lenticular lens L, the data targeted for the thinning-out processing becomes pieces of data included in long-shaped areas located at the left and right sides in the transportation direction among pieces of data corresponding to the outer areas each than a corresponding one of the edges of the lenticular sheet S. Further, in the case where the second apparatus 50 transports the lenticular sheet S in a direction orthogonal to the long-direction side of the lenticular lens L, the data targeted for the thinning-out processing becomes pieces of data included in long-shaped areas located at the front and back sides in the transportation direction among pieces of data corresponding to the outer areas each than a corresponding one of the edges of the lenticular sheet S. Further, for the pieces of data targeted for the thinning-out processing, when a rows of pixels arranged so as to correspond to the long-direction side of the lenticular kens L is defined as a pixel row PL, the thinning-out processing section 13c performs thinning-out processing on the targeted pieces of data by handling a predetermined number of the pixel row PL as unit of the thinning-out processing.

In step S150, the transfer section 13d rearranges the printing data 22′ having been subjected to the processing in step S140 into order in accordance with which the printing data 22′ is to be transferred to the print head 62, and then, sequentially transfers the rearranged printing data 22′ to the second apparatus 50 side via the transfer path 70. Through such rearrangement processing, for each of dots prescribed by the printing data 22′, it is decided, in accordance with its pixel position and its ink kind, through which of the nozzles of the printing head 62 and at which of timing points, ejection is to be performed. As a result, at the second apparatus 50 side, the lenticular image IM is frameless-printed on the lenticular sheet S on the basis of the printing data 22′.

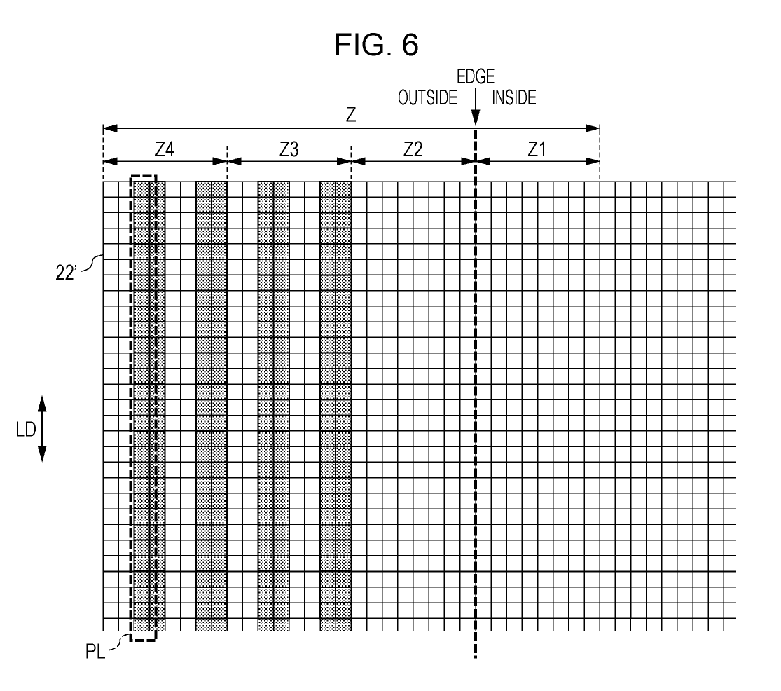

FIG. 6 is a diagram for describing an example of thinning-out processing the tinning-out section 13 performs in step S140. FIG. 6 illustrates part of the printing data 22′. Each of rectangular portions constituting the printing data 22′ is a single pixel. In FIG. 6, a position corresponding to an edge of a recording medium (the lenticular sheet S) is denoted by a thick chain line for the sake of convenience, and further, part of inner data and part of outer data than the edge are illustrated. In FIG. 6, a group of pixels located at the outer side than the edge is a target for the thinning-out processing. In FIG. 6, a direction LD is a direction the long-direction side of the lenticular lens L points to when the printing data 22′ is printed on the lenticular sheet S, and a row of pixels arrayed along the direction LD is the pixel row PL.

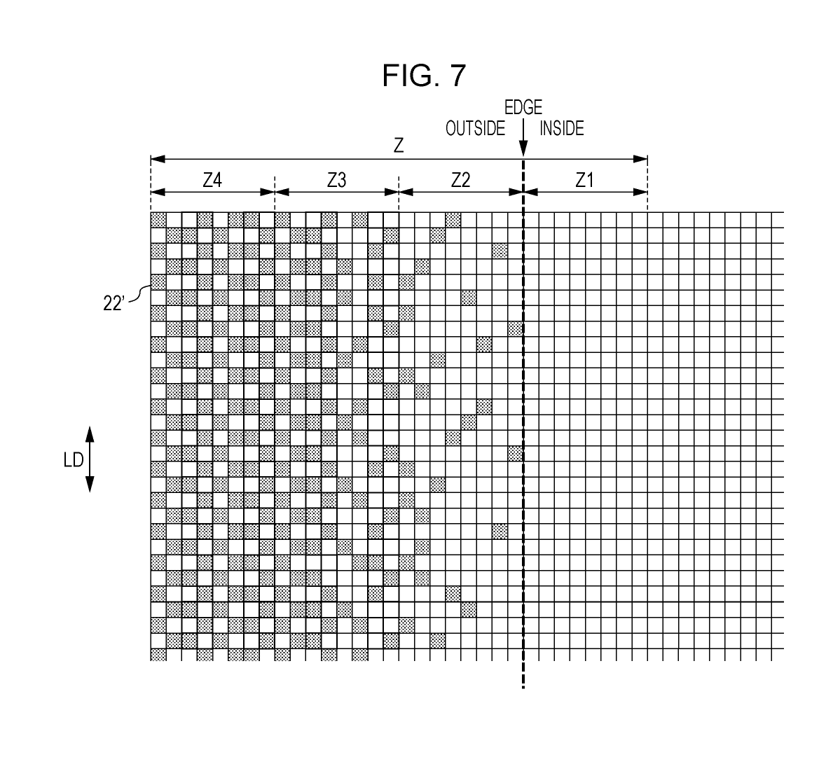

In FIG. 6 (and FIG. 7 shown below), pixels each filled in gray color are pixels targeted for the thinning-out processing (i.e., to-be-thinned-out pixels). Regardless of a result of the aforementioned halftone processing, for all the colors (C, M, Y and K in the aforementioned example), the thinning-out processing section 13c prescribes each of the to-be-thinned-out pixels as a dot-off dot. More specifically, a mask, which stores therein a value indicating a dot-off dot so as to correspond to each of positions of the to-be-thinned-out pixels, as shown in FIG. 6, and which stores therein a value “1” indicating a dot-on dot so as to correspond to each of positions of pixels other than the to-be-thinned-out pixels, is prepared in advance in a predetermined storage area (the HDD 20, the ROM 53 or the like). Further, the thinning-out processing section 13c acquires the mask and superimposes the mask onto the printing data 22′. Further, the thinning-out processing section 13c takes, for each pixel position, an AND operation of the value stored in the mask and a value (which indicates “1” for a dot-on dot or “0” for a dot-off dot) prescribed in the printing data 22′. Through this processing, for each of the to-be-thinned-out pixels, ejection of a corresponding dot is inhibited with certainty.

In the example shown in FIG. 6, the thinning-out processing section 13c handles two rows of the pixel row PL as unit of thinning-out processing, and performs the thinning-out processing on the pieces of data targeted for the thinning-out processing. Here, when it is supposed that the pieces of data targeted for thinning-out processing are printed on the lenticular sheet S, the predetermined number of the pixel row PL (two rows of the pixel row PL in the case of FIG. 6) are pixel rows corresponding to each of the above-described partial image areas (i.e., the images I1, I2, I3, I4, I5, I6, I7 and I8 (refer to FIG. 2)). Naturally, the “two rows” is just an example, and each of the images I1, I2, I3, I4, I5, I6, I7 and I8 may be a single pixel row, or may be three or more pixel rows. That is, it can be said that the thinning-out processing section 13c performs thinning-out processing on the pieces of data targeted for thinning-out processing by handling the above-described “viewpoint” as unit of the thinning-out processing.

Further, with respect to printing data corresponding to an outer area than an edge of the recording medium, when the outer area is divided into an area near the edge (a first area) and an area distanced from the edge (a second area), the thinning-out processing section 13c performs thinning-out processing on only a portion of the printing data, which corresponds to the second area. For example, as shown in FIG. 6, in a direction orthogonal to the direction LD, a certain area Z including an outer area than the edge and part of an inner area than the edge is supposed. Further, it is supposed that the area Z is equally divided into a plurality of areas along the direction orthogonal to the direction LD. In FIG. 6, these equally divided areas are made areas Z1, Z2, Z3 and Z4 from the inside towards the outside. In such a case, the thinning-out processing section 13c performs thinning-out processing on the areas Z3 and Z4 which are located distanced from the edge (these areas Z3 and Z4 corresponding to the second area), and does not perform thinning-out processing on the area Z2 which is located near the edge (this area Z2 corresponding to the first area).

FIG. 7 illustrates an example compared with the example shown in FIG. 6, and illustrates part of the printing data 22′, just like in the case of FIG. 6. FIG. 7 illustrates a case in which thinning-out processing is not performed on a unit basis of a predetermined number of the pixel row PL (i.e., on a viewpoint unit basis), as shown FIG. 6, but thinning-out processing is performed such that, for the whole pieces of data targeted for the thinning-out processing within the printing data 22′ (i.e., areas Z2, Z3 and Z4, that is, the first area and the second area), pixels are thinned out at regular or irregular intervals in each of two mutually orthogonal axis directions (i.e., the direction LD and the direction orthogonal to the direction LD). In addition, a thinning-out ratio with respect to the whole areas Z2, Z3 and Z4 in each of FIGS. 6 and 7 is made equal to each other. In such a comparison example (FIG. 7), although the thinning-out ratio is made higher as a target area is further distanced from the edge in order such as the area Z2, the area Z3 and the area Z4, some pixels are also thinned out in the area Z2. For this reason, in the case where part of inks (dots) to be thrown away lands on a recording medium due to a tilt of the recording medium in the state of being transported, error in the size the recording medium, and the like, a possibility that thinned-out pixels, that is, margins, appear on the recording medium is high.

Meanwhile, in this embodiment, as exemplified in FIG. 6, thinning-out processing is performed on only the second area. For this reason, even in the case where there exist a tilt of the recording medium in the state of being transported, error in the size of the recording medium, and the like, a possibility that thinned-out pixels (margins) appear on the recording medium is low, so that it is possible to suppress the degradation of an image quality.

In this embodiment, differing from the example shown in FIG. 7, thinning-out processing is performed on a unit basis of a predetermined number of the pixel row PL (on a viewpoint unit basis), and thus, it is easy to ensure a large thinning-out amount (a large number of thinned-out pixels) in a narrow area. That is, although the largeness of areas which are substantially subjected to thinning-out processing is narrower than that of the example shown in FIG. 7 (areas subjected to thinning-out processing being the areas Z2, Z3 and Z4 in the example shown in FIG. 7; while areas subjected to thinning-out processing being the areas Z2 and Z3 in this embodiment), the same thinning-out amount is kept, and thus, it can be said in this respect that this embodiment also brings about, with certainty, an advantageous effect of reducing an amount of inks thrown away.

In this embodiment, the thinning-out processing section 13c performs thinning-out processing on the pieces of data targeted for the thinning-out processing on the viewpoint unit basis described above, and thus, the following advantageous effects are brought about. That is, even in the case where, supposedly, ejection of inks based on pieces of data corresponding to areas (the areas Z3 and Z4) on which thinning-out processing has been performed results in inks landing on the lenticular sheet S, margins are merely generated on the viewpoint unit basis within the unit lenses La, that is, the number of viewpoints within the unit lenses La is merely reduced. According to this configuration, merely a three-dimensional appearance, as a printing result, at a vicinity of the edge of the lenticular image IM is slightly lost, and it can be said that the degradation of an image quality a user actually views is very little. In contrast thereto, as shown in FIG. 7, in the case where to-be-thinned-out pixels are two-dimensionally dispersed on a regular basis or on an irregular basis, when ejection of inks based on pieces of data corresponding to areas on which thinning-out processing has been performed results in inks landing on the lenticular sheet S, deficits occur in a larger number of viewpoints within the unit lenses La (that is, the number of the viewpoints within the unit lenses is not reduced but each of the viewpoints is likely to become in the state of including a deficit). Through this configuration, the degradation of an image quality at a vicinity of the edge of the lenticular image IM as a printing result results in distinct. Consequently, according to this embodiment, even in the case where, supposedly, ejection of inks based on pieces of data corresponding to areas on which thinning-out processing has been performed in order to reduce an amount of inks thrown away results in inks landing on the lenticular sheet S, the degradation of an image quality a user views can be suppressed as much as possible.

In addition, in the embodiment of thinning-out processing having been described in FIG. 6, as described above, the configuration is made such that the thinning-out processing on an area near the edge of the recording medium is not performed but the thinning-out processing on an area which is located at the outer side than the edge and which is further distanced from the edge is performed, and thus, it can be also said that a thinning-out ratio becomes higher as a target area becomes further distanced from the edge. Further, although, in the example shown in FIG. 6, a thinning-out ratio within each of the areas Z3 and Z4 (the second areas) on which tinning-out processing is performed is equal to each other, within these areas on which the thinning-out processing is performed, the thinning-out ratio may be caused to vary so as to become higher as a target area becomes further distanced from edge. For example, the thinning-out ratio may be set such that a thinning-out ratio within the area Z3<a thinning-out ratio within the area Z4.

### 4. Modification Example

The invention is not limited to the aforementioned embodiments. The invention can be practiced in various embodiments within a scope not departing from the gist of the invention, and, for example, can be practiced as modification examples described below. Configurations resulting from appropriately combining the aforementioned embodiments and modification examples are also included in the disclosure of the invention.

The aforementioned predetermined number of the pixel row PL, which is unit of thinning-out processing, have been made pixel rows corresponding to each of the aforementioned partial image areas (viewpoints), but these may not perfectly correspond to each other. For example, the predetermined number of the pixel row PL may be made pixel rows whose number is slightly smaller than the number of pixel rows corresponding to each of the aforementioned partial image areas (viewpoints) or, contrary, may be made pixel rows whose number is slightly larger than the number of pixel rows corresponding to each of the aforementioned partial image areas (viewpoints).

Further, in step S100, there is also a case where the printing control section 13 receives a user's direction for selecting a printing mode other than the first printing mode. For example, there is also a case where the printing control section 13 receives a direction for selecting a second printing mode for allowing frameless printing of a user's desired image (except a lenticular image) on a given recording medium other than the lenticular sheet S (for example, regular paper, glossy paper or the like). When such a direction for selecting the second printing mode has been received, image data representing the user's desired image is acquired in step S110, and then, in steps S120, S130 and S150, processes whose contents are similar to those described above are performed.

In step S140 in the case where the direction for selecting the second printing mode has been received, on all pieces of frame-shaped data corresponding to the outer area than the edge of the recording medium among pieces of printing data which have been subjected to the halftone processing and which are already received at the time, the thinning-out processing section 13c performs thinning-out processing for thinning out pixels at regular or irregular intervals in each of mutually orthogonal two axis directions. That is, in the second printing mode, for all pieces of frame-shaped data corresponding to the outer area than the edge of the recording medium, as described in FIG. 7, thinning-out processing is performed such that it is regularly or irregularly dispersed in two dimensional directions, and further, a thinning-out ratio is made higher as a target area becomes further distanced from the edge of the recording medium.

The second printing mode is a mode for frameless printing other than frameless printing on the lenticular sheet S. In the case where thinning-out processing is performed on a unit basis of a predetermined number of the pixel row PL, such as described in FIG. 6, when ejection of inks based on pieces of data corresponding to areas on which thinning-out processing has been performed results in inks landing on the recording medium, stripe-shaped margins occur at a vicinity of the edge of the recording medium, and on a recording medium which is not the lenticular sheet S, such stripe-shaped margins are viewed as they are, and are rather likely to become a cause which degrades estimation of the image quality. For this reason, in the case where the second printing mode has been directed, in contrast to the case of the first printing mode, a configuration is made such that the degradation of an image quality, which is caused by an event in which ejection of inks based on pieces of data corresponding to areas on which thinning-out processing has been performed results in inks landing on a recording medium, is suppressed by performing thinning out processing having a high dispersion property, such as described in FIG. 7.

The halftone processing in step S130 and the thinning-out processing in step S140 may be performed simultaneously. That is, in the halftone processing, when the dot-on or dot-off is determined for each pixel, simultaneously therewith, the mask for use in the thinning-out processing may be applied.

In addition, description has been made so far by way of an example in which processing shown in FIG. 3 is performed at the first apparatus 10 side, but at least part of the processing may be performed at the second apparatus 50 side. For example, the configuration may be made such that the firmware FW executes the processes in steps S100 to S140, printing data resulting from these processes is outputted to the ASIC 56, and then, printing in accordance with the printing data is performed.

What is claimed is:

1. A printing control apparatus for controlling printing on a lenticular sheet, comprising:
a printing control section that generates, from image data for use in the printing on the lenticular sheet, printing data corresponding to an area included in the lenticular sheet as well as another printing data corresponding to at least one area extending outward from an edge of the lenticular sheet, and that performs printing by using the printing data and the another printing data,
wherein the printing data and the another printing data are composed of a plurality of pixels, and for the another printing data corresponding to the outer area than the edge, when a row of pixels being included in the plurality of pixels and aligning so as to correspond to a long-direction of a lenticular lens is defined as a pixel row, the printing control apparatus performs thinning-out processing by handling a predetermined number of the pixel row as unit of the thinning-out processing.

2. The printing control apparatus according to claim 1, wherein the image data for use in the printing on the lenticular sheet is arranged so as to cause a plurality of partial image areas to correspond to a short-direction of the lenticular lens, and the predetermined number is a total number of a plurality of the pixel rows which is associated with a corresponding one of the partial image areas.

3. The printing control apparatus according to claim 1, wherein the printing control section is configured to, for the another printing data corresponding to the outer area than the edge, make a thinning-out ratio higher as being further distanced from the edge.

4. The printing control apparatus according to claim 1, wherein the printing control section is configured to, for the another printing data corresponding to the outer area than the edge, perform dividing into a first area near the edge and a second area distanced from the edge, and perform the thinning-out processing on only the second area.

5. A printing control method for controlling printing on a lenticular sheet, comprising:
a printing control process that generates, from image data for use in the printing on the lenticular sheet, printing data corresponding to an area included in the lenticular sheet as well as another printing data corresponding to at least one area extending outward from an edge of the lenticular sheet, and that performs printing by using the printing data and the another printing data,
wherein the printing data and the another printing data are composed of a plurality of pixels, and for the another printing data corresponding to the outer area than the edge, when a row of pixels being included in the plurality of pixels and aligning so as to correspond to a long-direction of a lenticular lens is defined as a pixel row, the printing control process performs thinning-out processing by handling a predetermined number of the pixel row as unit of the thinning-out processing.

6. A non-transitory computer readable storage medium storing computer program by which printing on a lenticular sheet is controlled, the program causing a computer to execute:
generating, from image data for use in the printing on the lenticular sheet, printing data corresponding to an area included in the lenticular sheet as well as another printing data corresponding to at least one area extending outward from an edge of the lenticular sheet; and
performing printing by using the printing data and the another printing data,
wherein the printing data and the another printing data are composed of a plurality of pixels, and for the another printing data corresponding to the outer area than the edge, when a row of pixels being included in the plurality of pixels and aligning so as to correspond to a long-direction of a lenticular lens is defined as a pixel row, thinning-out processing is performed by handling a predetermined number of the pixel row as unit of the thinning-out processing.
